(19) United States
(12) Patent Application Publication
(10) Pub. No.: US 2013/0246345 A1
(43) Pub. Date: Sep. 19, 2013

(54) SYSTEMS AND METHODS FOR ONLINE WORKFLOW IMPLEMENTATION

(71) Applicants: Michael Eisler, Eidenberg (AT); Dieter Dobersberger, Engerwitzdorf (AU); Harald Weiss, (US); Christian Herbert Leeb, Linz (AT); Manuel Bernd Berger, Leonding (AT)

(72) Inventors: Michael Eisler, Eidenberg (AT); Dieter Dobersberger, Engerwitzdorf (AU); Harald Weiss, (US); Christian Herbert Leeb, Linz (AT); Manuel Bernd Berger, Leonding (AT)

(73) Assignee: Wappwolf, Inc., San Francisco, CA (US)

(21) Appl. No.: 13/615,055

(22) Filed: Sep. 13, 2012

Related U.S. Application Data
(60) Provisional application No. 61/534,234, filed on Sep. 13, 2011.

(51) Int. Cl. G06F 17/30

(52) U.S. Cl. CPC G06F 17/30011
USPC 707/608

(57) ABSTRACT

A system, computer-readable storage medium storing at least one program, and a computer-implemented method for online workflow implementation is provided. An input identifier identifying a digital content to be processed is received. A workflow identifier is also received, the work flow identifier identifying a workflow comprised of a plurality of ordered applications. The digital content is then processed in accordance with the workflow to generate a final output.

### RELATED APPLICATIONS

This application claims the benefit under 35 U.S.C. 119(e) of U.S. Provisional Patent Application Ser. No. 61/534,234 filed Sep. 13, 2011, which is incorporated herein by reference in its entirety and made a part hereof.

### TECHNICAL FIELD

This patent document pertains generally to the technical field of data processing and networked communications and more particularly, but not by way of limitation, to systems and methods for online workflow implementation.

### BACKGROUND

Many people today use computers to create, store, process and/or share digital content items. Examples of common digital content items include, for example, photographs (or other images), videos, documents, and music (or other audio).

A myriad of applications exist for processing/manipulating digital content. An application will typically receive a content item as an input, process the content item in order to achieve the desired task, and output the processed content item. Given the sheer number of applications available, however, identifying the types of applications available to achieve a particular task, and locating specific instances of such applications (given there may be a multitude of applications that can be used to achieve the same end) can be time consuming. Once a desired application has been found, it is typically then downloaded by a user, installed on the user's local machine, and executed in order to process the application. This process can (again) be time consuming and can present technical difficulties. Further, in some instances installing and/or executing applications can present a computer security risk.

Exacerbating this problem is the fact that often a single application may not be capable of achieving a user's desired end. In this case the user must find multiple applications which when successively used to process a content item achieve the desired end. In addition to having to deal with the issues outlined above with respect to each individual application required, selecting multiple applications to operate together can present further selection difficulties (e.g. in ensuring that application inputs/outputs are compatible and will eventually achieve the desired end), and operational difficulties (e.g. in actually planning and executing a workflow using the applications).

Technical challenges exist in providing simple and convenient access to and use of online applications.

### BRIEF DESCRIPTION OF DRAWINGS

Some embodiments are illustrated by way of example and not limitation in the figures of the accompanying drawings in which:

FIG. 1 is a network diagram depicting a system in which embodiments of the invention may be deployed.

FIG. 2 is a depiction of a workflow creation interface in accordance with an embodiment of the invention.

FIG. 3 is a flowchart of example operations for creating a workflow in accordance with an embodiment of the invention.

FIG. 4 is a depiction of a workflow selection interface in accordance with an embodiment of the invention.

FIG. 5 is a flowchart of example operations for selecting a workflow in accordance with an embodiment of the invention.

FIG. 6 is a depiction of a workflow execution interface in accordance with an embodiment of the invention.

FIG. 7 is a flowchart of example operations by which a user may execute a workflow in accordance with an embodiment of the invention.

FIG. 8 is a flowchart of example operations for executing a workflow in accordance with an embodiment of the invention.

FIG. 9 is a depiction of a developer contribution interface in accordance with an embodiment of the invention.

FIG. 10 is a flowchart of example operations for contributing an application in accordance with an embodiment of the invention.

FIG. 11 is a diagrammatic representation of a machine in the example form of a computer system within which a set instructions, for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

### Overview

Embodiments of the invention provide users with the ability to create, edit, select, and execute workflows in a networked environment. As used herein, a workflow will refer to a grouping of two or more applications which are called in sequence to perform operations on a content item. Execution of a workflow involves passing the input content item defined by a user to the first application in the workflow (along with any parameters relevant to execution of that application in the workflow). The first application processes the content item, generating an output. The output of the first application is then passed to the second application in the workflow for execution by that application (once again, along with any parameters relevant to the execution of the application). This process is repeated for however many applications are involved in the workflow, with the output of the final application being the result sought after by the user.

More generally speaking, for a workflow involving n applications: the input for the first application is a content item defined by a user and any parameters used in execution of the first application; the input for the 2^{nd} to nth application is the output generated by the nth−1 application and any parameters used in execution of the nth application.

In one embodiment, automations are created to execute workflows automatically on all content items contained in a specified directory. As used herein, automations simply refer to a workflow that is associated with a specific directory. Automations execute a workflow on every content item contained within a directory that matches the file types defined by the automation. Every time a new content item appears in the folder or directory, the automation processes the new file or content item in accordance with the user defined workflow.

A brief overview of various types of content items that may be processed, and of the types of applications which may be used to perform that processing, in embodiments of the invention will be provided.

### Content Items

A huge variety of digital content types exist. These include photograph/image content (e.g. .jpg, .gif, .bmp files), technical drawing content (e.g. .cad, .skp, .dwg, .vsd files), audio content (e.g. .wav, .mp3, .aiff files), video content (e.g., .avi, .mpeg4.wmv files), document content (e.g. .doc, .txt, .pdf files), spreadsheet content (e.g. .xls files), presentation content (e.g. .ppt files), database content (e.g. mdb files), web page content (e.g. .html files), etc.

The above content types and file extensions are provided by way of example only, and do not represent a complete list of either content types or file extensions related to those content types. Various features and embodiments of the present invention may well be used with content and/or file types not specifically enumerated above.

### Applications

In addition to there being a variety of content types, there is also a wide assortment of applications that can be employed by embodiments of the present invention to process content items. Generally speaking, applications may include input applications for accessing content items, action applications which process content items to perform an action on a content item, and output applications which process content items to output them.

In one embodiment the applications used in workflows are Simple Object Access Protocol (SOAP) web-services.

By way of example, input applications may include applications such as: upload applications which allow a user to upload content items from a locally accessible storage device; email applications which allow content items to be accessed via email; ftp applications which allow content items to be accessed from a ftp site; network access applications which allow content items to be accessed from a network service or application (e.g. a social media/networking site, a Dropbox or Dropbox-type service, etc).

Examples of action applications include: text recognition applications; content augmentation applications which, for example, may be used to add a signature or other data to a content item; content distillation applications which may be used to summarize the contents of a content item (typically applied to textual content); content interpretation applications usable to, for example, read a barcode, QR code, or other code and retrieve data related to the code; compression applications usable to compress and decompress content items; encryption applications, usable to encrypt and decrypt content items; translation applications usable to translate textual matter in a content item from one language to another; conversion applications usable to convert a content item of one format to another; metadata editing applications usable to edit, update or add to metadata (e.g. a file name) associated with a content item; rating applications usable to rate (e.g. like/dislike etc) a content item); image manipulation applications usable, for example, to rotate, resize, crop, adjust levels, or otherwise modify image content items. Likewise, audio, video and other content may have appropriate action applications.

Examples of output applications may include: save applications which save a content item to an available location (e.g. a hard drive, a flash drive, a CD, a DVD, a network attached storage device, a network accessible storage location such as a Dropbox); email applications which email a content item to one or more email addresses; fax applications which fax a content item to one or more fax numbers; SMS applications which SMS a content item to one or more phone numbers; mail applications which output content items for delivery to one or more physical addresses; FTP applications which output content items to one or more FTP servers.

Further output applications may include social media/networking output applications which output content to a social media service. Such applications may include applications which output content by posting it, for example, to: Facebook (e.g. as an image or as a status update); Twitter; Google+; Picasa; imgur; Flickr; YouTube; Vimeo; blog services.

Some applications are relevant only to specific types of content. For example, image manipulation applications will typically only be relevant to image type content items. Other applications, however, may be applied to almost any type of content. For example, compression, encryption, and communication applications (e.g. email applications) can typically be used on content items of any type.

Some (though not all) applications will have one or more parameters relevant to the execution of the application. For example: an image rotation application typically has parameters allowing the user to define the direction and degree of rotation; an image resize application parameters defining the intended size; a compression application defining the desired size and/or compression algorithm; an encryption algorithm parameters to define the encrypt/decrypt password and/or encryption algorithm; an SMS application a parameter defining the phone number(s) of the addressee(s); an email application parameters defining one or more recipient email addresses (to, cc, bcc), a from address, a subject, and body; and applications which interface with social media/networking services parameters defining the login and authentication details of the user.

In another embodiment, other parameters, known as file elements, are included in text fields of an action application. For purposes of the present application, file elements are parameters (e.g. download link, name, description, file size, etc.) that may be added to text fields in actions. For example, an action application may include a parameter which automatically provides a download link in an email notification to allow the user to access a content item after it has been processed. In an example embodiment, file elements are used in combination with an automation to alert a user that a content item has been added to a directory and processed by the workflow.

Once again it is noted that the applications above are provided by way of non-limiting example only, and embodiments of the invention may well make use of numerous additional applications with additional and/or alternative parameters. Further, embodiments of the invention allow developers to develop their own applications and submit these for use with the system.

### Platform Architecture

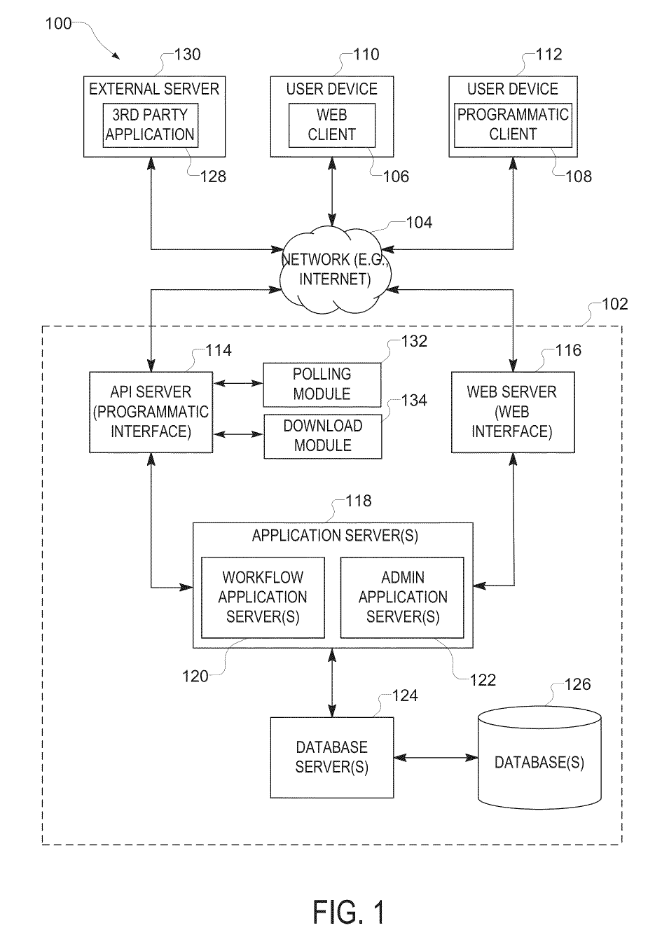

FIG. 1 is a network diagram depicting a client-server system 100, within which one example embodiment may be deployed. A networked workflow system 102 provides server-side functionality, via a network 104 (e.g., the Internet or other network such as a Wide Area Network (WAN)) to one or more clients running on user devices such as devices 110 and 112.

A variety of clients capable of interacting with the workflow system 102 are possible. These may include, for example, web clients 106 such as the Internet Explorer, Firefox, Mozilla, Safari, Chrome web browser applications. Clients may also include programmatic clients 108 running on a user device 112. Programmatic clients are developed specifically for interaction with the workflow system 102 and may include, for example, programmatic clients developed for specific devices and/or operating systems (e.g. Microsoft Windows clients, Apple OS clients, iPhone clients, iPad clients, etc). Programmatic clients 108 may also be provided as add-in's or modules designed to operate as part of other applications (e.g. word processing applications such as Microsoft Word, email applications, etc), and allow the other application to interact directly with the workflow system 102.

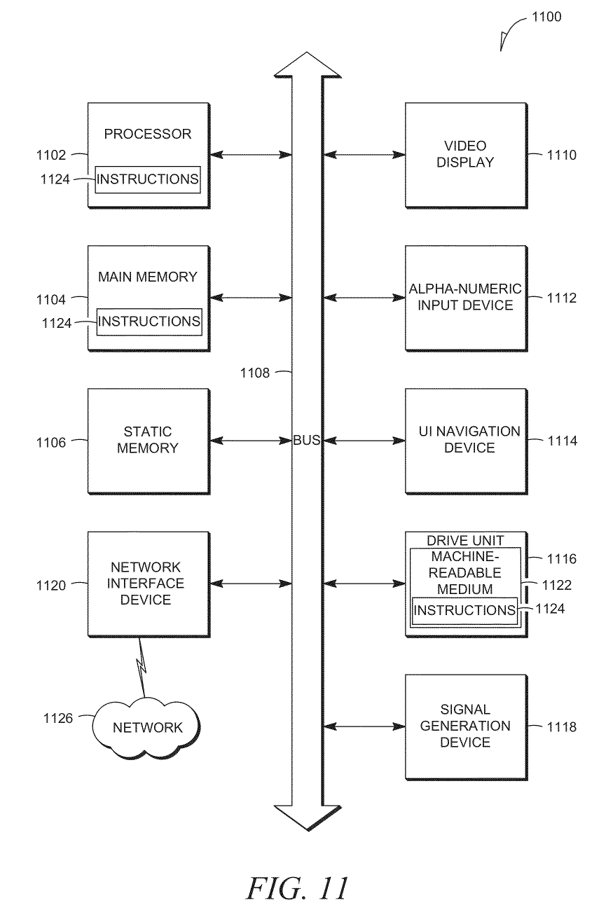

Broadly speaking, the workflow system 102 and user devices 110 or 112 may be any computing device (or combination of computing devices) capable of communicating with each other over a network. As discussed in further detail below with reference to FIG. 11, such devices may be desktop computers, laptop computers, tablet computers, mobile phones, games consoles, or set top boxes.

Within the workflow system 102 an Application Program Interface (API) server 114 and a web server 116 are coupled to, and provide programmatic and web interfaces respectively to, one or more application servers 118. The API server 114 includes a service API which provides for communication (e.g. data and parameter passing) between the workflow application server 120 and applications being executed on external servers such as server 130. For example, the server API provides data services such as fetching user-specific data to a particular workflow instance (e.g. to authenticate a user executing an application). A port handler is also provided which handles workflow-start requests and communicates with the workflow application server 120. The port handler can both store (spool) workflows/files that are to be executed and commence execution of workflows when they become ready for execution.

The application servers 118 in this instance include one or more workflow application servers 120 and one or more administrative application servers 122. In one embodiment the workflow application server 120 is based on the Open Source WSO2, which in turn is passed on to the Apache Orchestration Director Engine (ODE).

The application servers 118 are, in turn, coupled to one or more database servers 124 that facilitate access to one or more databases 126. Database server 124 may store and access data on the databases 126 in accordance with a database schema. In one embodiment the database structure is a relational database.

As described in further detail below, the workflow application servers 120 provide a number of workflow related functions and services to users that access the networked system 102. Broadly speaking the workflow related functions include workflow creation, selection, and execution functions, together with application submission functions.

The administrative application servers 122 may likewise provide a number of administrative services and functions to users, such as user account applications and payment applications. The administrative application servers 122 may allow users to accumulate value (e.g., in a commercial currency, such as the U.S. dollar, or a proprietary currency, such as “credits” or “points”) in accounts, and then to redeem the accumulated value in executing workflows. While both the workflow and administrative application servers 120 and 122 are shown in FIG. 1 to form part of the networked workflow system 102, it will be appreciated that, in alternative embodiments, some or all of administrative applications 122 (e.g. payment related applications) may form part of a service that is separate and distinct from the networked workflow system 102.

Further, while the workflow system 100 shown in FIG. 1 employs a client-server architecture, the present invention is not limited to such an architecture, and could equally well (for example) find application in a distributed, or peer-to-peer, architecture system.

The web client 106 accesses the various services and functions provided by the workflow and administrative application servers 120 and 122 via the web interface supported by the web server 116. Similarly, the programmatic client 108 accesses the various services and functions provided by the workflow and administrative application servers 120 and 122 via the programmatic interface provided by the API server 114.

FIG. 1 also illustrates a third party application 128, executing on an external server machine 130, as having programmatic access to the networked workflow system 102 to allow for networked communication therewith. For example, the third party application 128 may provide a user with access to content items or applications, and or present a service by which content items can be output (such as a social media service on which content items may be posted/otherwise uploaded to). Applications (e.g. SOAP web-services) may also be hosted on external servers 130 and accessed/communicated with during execution of workflows. Several third party applications hosted on one or more external servers may well be accessed by the workflow system 102 during the execution of a given workflow.

FIG. 1 also illustrates polling module 132 and downloader module 134 coupled to the API server 114. The polling module 132 and download module 134 provide automation capabilities to allow a user to execute a workflow on every content item contained in a specified directory. When associated with a particular directory an automation automatically executes a specified workflow and processes each new content item of matching file type that is added to the automated directory. The matching file types and other parameters necessary for the execution of the workflow (e.g., email address of the intended recipient of the content item) are defined by the automation.

The polling module 132 iterates through each content item in the automated directory and determines whether a new content item has been added. Upon the determination that a new content item has been added to an automated folder, the polling module 132 notifies the API Server 114 that a content item has been added. The API Server 114 transmits a notification to the download module 134 so that it may retrieve the content item from the database server 124. In another embodiment, the content item is located on a 3rd party server, such as 3^{rd} party server 130. Once the file or content item is retrieved by the download module 134, the content item along with any necessary additional parameters is processed in accordance with the workflow.

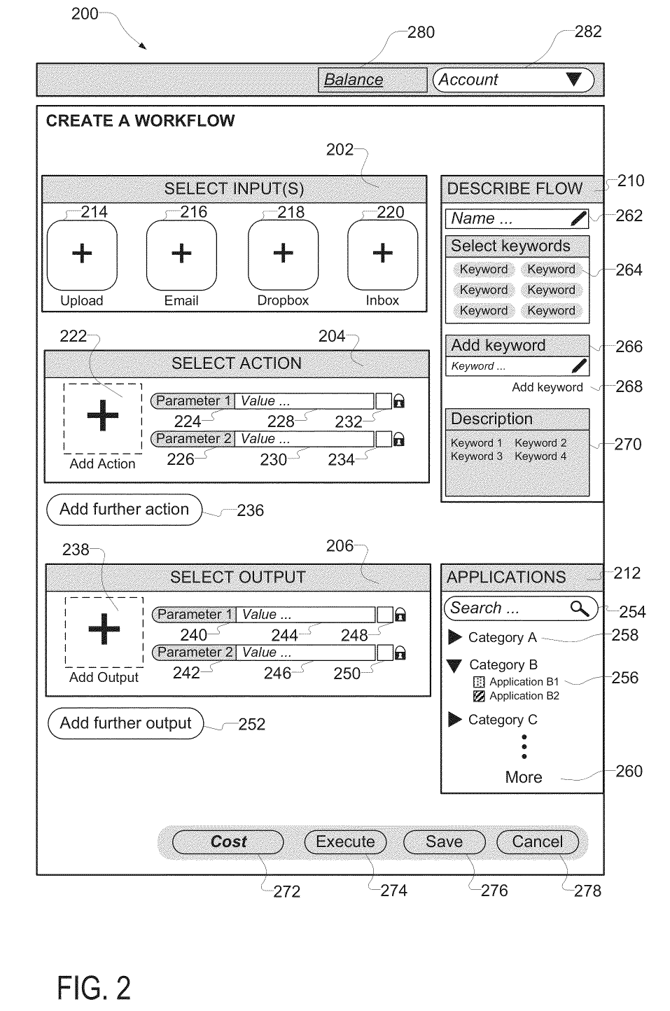

The workflow system 102 is configured to provide methods and interfaces with which users may interact with the system 102 to perform various functions. By way of example, a workflow creation interface 200 and method 300, a workflow selection interface 400 and method 500, a workflow execution interface 600 and methods 700 and 800, and a developer contribution interface 900 and method 1000 will now be described with reference to FIGS. 2 to 10 respectively. Interfaces 200, 400, 600, and 900 may be provided via the web or programmatic interface 116 or 114 of the workflow system 102, and accessed by/viewed by a user of a user device such as device 110 or 112.

### Workflow Creation

FIG. 2 provides a depiction of a workflow creation interface 200 in accordance with an embodiment of the invention, from which a user can create workflows. As can be seen, the workflow creation interface 200 of this embodiment includes an input selection panel 202, an action selection panel 204, an output selection panel 206, a description panel 210, and an application search/selection panel 212.

Input selection panel 202 provides users with a selection of different input options. In this instance the input options provided include an upload option 214 (allowing a user to select a content item from a location local to the user such as a hard drive or other attached storage device), an email option 216 (allowing a user to email a content item to the workflow system for processing), a Dropbox option 218 (allowing a user to select a content item from a Dropbox or like service), and an inbox option 220 (allowing a user to select a content item from an email inbox). Other input options may, of course, be provided as additional or alternative input options. A user can select one or more desired input options by, for example, clicking or otherwise activating the relevant icon.

In some cases a user may not wish to select an input at the workflow creation stage, instead allowing the input of the workflow to be selected on execution, providing the workflow with the flexibility to be executed with multiple different inputs.

Action selection panel 204 allows a user to select an action application which, when the workflow is executed, will be used to process the input content item(s). Action applications are selected by clicking on (or otherwise activating) add action button 222. Doing so allows a user to select an action application from an application selection interface such as panel 212, described further below. Once a user has selected an action application from the action selection interface a representation of the selected action application (e.g. text and/or an icon) is displayed in place of the add action button 222.

As described below, when an application is submitted for use with the workflow system 102, parameters relevant to the execution of the application are also defined. If an application selected for inclusion in a workflow has parameters that can or must be defined for correct operation, these are displayed allowing the user to specify the desired values. If desired a user can defer defining application parameters at this stage, in which case the parameters are defined on execution of the workflow as described below. In this instance two generic parameters are indicated. Each parameter has a parameter label 224 and 226 (describing the nature/purpose of the parameter), and a value entry field 228 and 230 (allowing the user to define the value of the parameter to be passed to the application on execution). Value entry fields 228 and 230 may allow for parameters to be defined in a number of ways, for example by free-form text or a parameter selection tool (e.g. a drop down box or a link to a parameter selection interface). Depending on the parameter in question, the value field may be pre-populated with a suggested value—for example, a most commonly selected parameter value, or a parameter value saved by the user with their user account details. By way of non-limiting example, if the selected application is an image rotation application, parameter 1 224 may be “rotation type”, and value 228 may allow a user to select (e.g. via a drop down box) “clockwise” or “counterclockwise”. Parameter 2 226 may be “degrees”, and value 230 may allow a user to enter how many degrees the input content item is to be rotated. By way of further example, the rotation type value may be pre-populated to “clockwise”, and the rotation value field pre-populated at “90°”.

Each parameter 224 and 226 also has a save checkbox 232 and 234 respectively. By selecting a save checkbox 232 or 234 the entered parameter for the application is saved, and when the workflow is executed by a user (as discussed below) the saved values are prepopulated for the saved parameter. Conversely, if a parameter is not saved the entered value will not be saved with the workflow.

Having selected a first action application, a user may elect to add further action applications to the workflow by activating the add further action control 236. If a user activates the add further action control 236, an additional action selection panel 204 is displayed, allowing the user to select a further action application and define any relevant parameters as described above. A user may add as many action applications to a workflow as is desired. Each subsequent application must have an input file format type that matches the output file format type of the preceding application. If a user attempts to select an application with an input file format that is incompatible with the preceding application, the system will prompt the user to make a different selection.

In some workflows an action application may not be necessary. For example, should a user wish to create a workflow which simply takes a content item and outputs it (e.g. by emailing or posting to a social networking site such as Facebook), no action application need be selected.

The output selection panel 206 allows a user to select one or more output applications for the workflow being created. Output applications for the workflow are selected, and any parameters to those applications defined, in a similar fashion to the action selection described above. A user selects an output application by activating the add output button 238 which allows a user to select an output application from an application selection interface (such as application selection panel 212). Once an output application has been selected an icon representing the selected output application is provided in place of add output button 238, and any relevant parameter entry fields are displayed. In this example two generic parameter entry fields are displayed, each with a label (240 and 242 respectively) defining the nature of the parameter, an input field (244 and 246 respectively) allowing the value of the parameter to be defined, and a save selector (248 and 250 respectively) allowing the parameter value to be saved for prepopulation on execution of the workflow as described above.

As with the action selection panel 204, the workflow system 102 may be configured to pre-populate the input field for certain parameters with suggested parameter values. For example, if the output application selected is email (and the user is creating the workflow is logged into a user account held with the system 102), the system 102 may access the email address associated with the user account and suggest this as the value of a “from” parameter. Similarly, a user may have saved certain social media/networking service user name and authentication details to their account, which can then be automatically populated as application parameters where appropriate.

Having selected a first output application, a user may elect to add further output applications to the workflow by activating the add further output control 252. If the add further output control 252 is activated, an additional output selection panel 206 is displayed, allowing the user to select a further output application and define any relevant parameters as described above. A user may add as many output applications to a workflow as is desired.

As noted above, when a user selects to add an action application or an output application to a workflow (e.g. by selection of control 222 or 238 respectively) an application selection interface is enabled. In this instance the application selection interface includes panel 212. Panel 212 provides a search box 254 in which a user can enter a search term (e.g. a keyword search) and a list of applications. In this particular depiction no user search has been executed, and a default set of applications are listed in the panel 212. The applications 256 (in this instance application B1 and application B2) are divided into categories 258 (in this instance categories A, B, and C). By way of example, application categories may include categories such as popular applications, image applications, document applications, video applications, pdf applications, favorite applications, saved applications, all applications etc. If an application search is executed (using search field 254), search result applications will be displayed in place of the default applications. In order to select an application a user may click on the desired application or drag the desired application from the application selection panel 212 to either the add action button 222 or add output button 238.

Should a user wish to undertake a more rigorous search of applications, this may be done by activating the “more” control 260, which launches a further application selection interface (not shown). The further application selection interface may allow a larger number of applications to be viewed at once, and provide greater search options for the user.

The workflow description panel 210 allows a user to name and describe the workflow being created. This allows the user (or, depending on the accessibility for the workflow defined by the user, other users of the workflow system 102) to search for the workflow at a later date. Workflow description panel 210 includes a name field 262 in which a user can enter a name for the workflow, and controls by which a user can assign keywords to the workflow being created. Keywords may be assigned either by selecting existing keywords 264 (by, for example, clicking on the existing keywords 264 or dragging keywords 264 into the description panel 270) or by entering a new keywords in field 266 and selecting to add that keyword by control 268. Selected keywords are displayed in the description panel 270.

The workflow creation interface 200 also includes a cost indicator 272, an execute control 274, a save control 276, and a cancel control 278.

Cost indicator 272 displays the total cost that will be incurred by a user who executes the workflow being created. In one embodiment of the invention, each application has an associated per-execution cost (which may be zero) that is charged each time the application is executed. In this case the cost indicator 272 indicates the sum of the credit costs of all selected applications. Where a user has a user account with the workflow system and is logged on, the amount of currency (e.g. credits) available to the user is also displayed at account balance indicator 280.

The execute control 274 allows a user to execute the created workflow. If the workflow has not been saved the system 102 may be configured to prompt the user with the option of saving the workflow before execution.

The save control 276 allows a user to save the created workflow. In some embodiments activation of the save control 276 launches a save interface, allowing a user to select how the workflow is to be saved. For example, the user may save the workflow so that it is accessible/visible only to themselves, such that it is visible to one or more contacts or groups of contacts as selected by the user, or such that it is accessible by any users of the workflow system 102.

The cancel control 278 allows a user to cancel the workflow being created. On activation of the cancel control 278 the system may prompt the user to confirm the cancel operation, query the user as to whether the workflow should be saved prior to cancelling, or may simply cancel the workflow without such prompting/querying.

In one embodiment some user input fields will be mandatory. For example, the workflow system 102 will typically require that the user define a name for the workflow and select at least one output for the workflow. If any mandatory fields have not been entered and the user attempts to save or execute the workflow, the system 102 will warn the user of any missing mandatory fields and prompt the user to complete the fields before saving/executing the workflow.

An account control 282 is also provided to enable users to access various user account tools and functions. Such tools/functions may include, for example functions allowing the user to log in, to log out, add value to their account (to allow workflows to be executed), and to amend their user account details.

While the example workflow creation interface 200 includes an input selection panel 202, action selection panel 204, output selection panel 206, workflow description panel 210, and application selection panel 212 on the same interface, one or more of these panels (or the functions offered thereby) may, of course, be provided on separate interface screens, launched by a user on activation of an appropriate control.

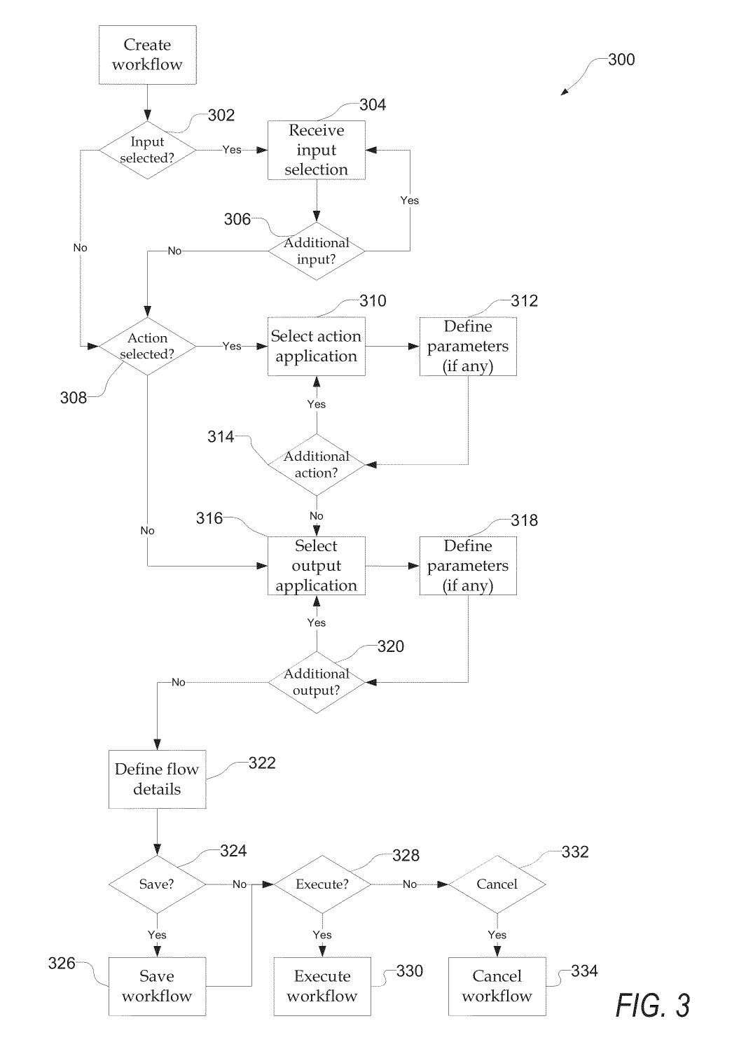

FIG. 3 is a flow chart illustrating a method 300 for creating a workflow in accordance with an example embodiment of the invention. The method 300 may be enabled by any appropriate module, logic, or component described herein, and may be implemented using a workflow creation interface such as interface 200 described above.

If a user elects to select an input for the workflow (at block 302), an input identifier indentifying the input (for example the type of input and any input parameters) is received at block 304. At block 306 the user may elect to define an additional input for the workflow.

If a user elects to select an action application for the workflow (at block 308), the specific application is selected at block 310. If relevant to the selected action application the user may also elect to define application parameters at block 312. At block 314 the user may elect to add a further action application to the workflow

At block 316 the user selects an output application for the workflow. The user may also elect to define parameters for the output application at block 318. At block 320 the user may elect to add a further output application to the workflow.

At block 322 the user defines the workflow, for example by entering a workflow identifier and/or one or more workflow keywords.

The user may then elect to save the workflow at block 324. If the user elects to save the work flow and all mandatory fields have been entered, the system 102 saves the workflow data entered by the user at block 326. The data is received at the system 102 and saved to a database such as database 126. If the system is configured such that some fields are mandatory, and one or more mandatory fields have not been entered by the user, a warning/prompt may be displayed alerting the user of this.

At block 328 the user may elect to execute the workflow. In this case the system 102 saves the workflow data entered by the user and executes the workflow using that data at block 330 (as described in further detail below).

Alternatively, a user may elect to cancel the workflow at block 332. In this case the system 102 clears any data entered by the user and, for example, returns the user to a homepage or similar where the user may choose to undertake further actions with the system (block 334).

Although presented as a flowchart, it will be appreciated that the steps/blocks involved in creating a workflow need not be performed in the order shown. For example, a user may well elect to name the workflow and select/define any keywords as first or intermediate step instead of leaving this to the final step before saving/executing. Similarly, workflow inputs, actions, and outputs may be entered by a user in any desired order.

### Workflow Selection

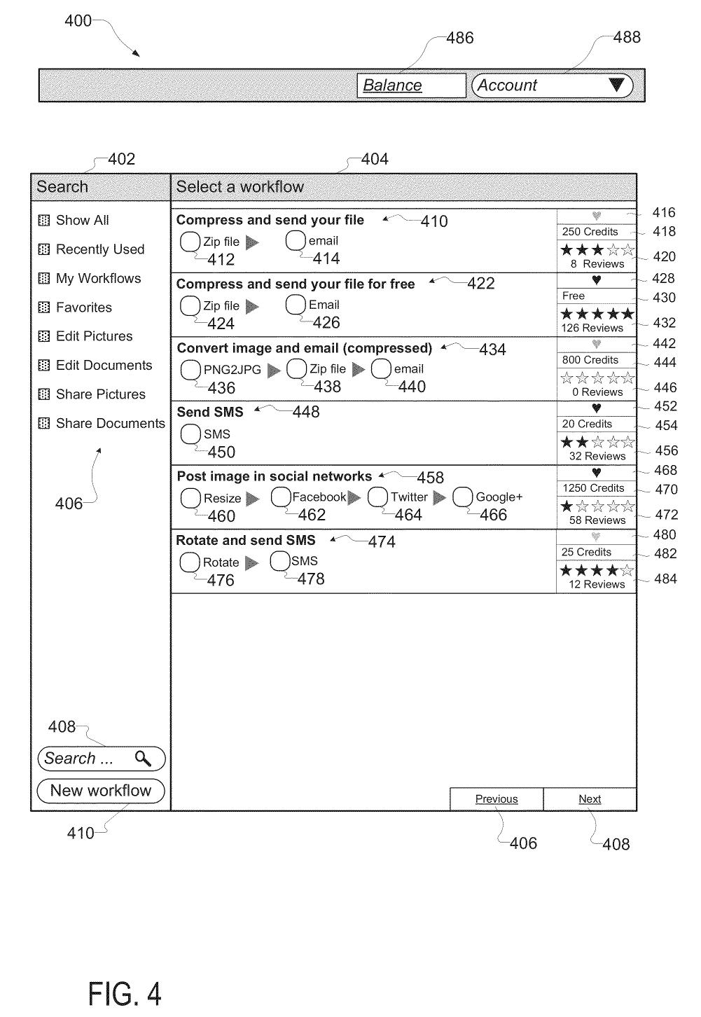

FIG. 4 provides a depiction of a workflow selection interface 400 in accordance with an embodiment of the invention, and which allows a user to select a workflow for execution.

Broadly speaking, workflow selection interface 400 includes a search panel 402 and a workflow selection panel 404.

The search panel 402 provides users with the ability to search for workflows that are available for execution. Tools provided for this purpose include various workflow category selectors 406, which in this case include: a “show all” category which, if selected, displays all workflows available to the user in the workflow selection panel 404; a “recently used” category which, if selected, displays all workflows recently used by the user in the workflow selection panel 404; a “my workflows” category which, if selected, displays all workflows created and saved by the user in the workflow selection panel 404; a “favorites” category which, if selected, displays a users' favorite workflows in the workflow selection panel 404; an “edit pictures” category which, if selected, displays in the workflow selection panel 404 all workflows available to the user which deal with editing/manipulating picture content items; an “edit documents” category which, if selected, displays in the workflow selection panel 404 all workflows available to the user which deal with editing/manipulating document content items; a “share pictures” category which, if selected, displays in the workflow selection panel 404 all workflows available to the user which deal with sharing picture content items; and a “share document” category which, if selected, displays in the workflow selection panel 404 all workflows available to the user which deal with sharing document content items. Additional and/or alternative workflow categorizations are, of course, possible.

Search panel 402 also provides the user with a search box 408 which allows the user to search for workflows which have been assigned specific keywords (e.g. in the workflow description process described above).

If a user has not selected a category 406 or entered a search using box 408, system 102 may be configured to show a default set of workflows in selection panel 404. The default selection may, for example, be one of the categories 406, a random selection of available workflows, or a selection made according to any other criteria.

A new workflow control 410 is also provided, allowing a user to create a new workflow. Activation of the new workflow control 410 launches/navigates the user to a workflow creation interface such as interface 200 described above.

Search result workflows are displayed in the workflow selection panel 404. In this instance six workflows are depicted, though more or fewer results could be displayed. If the number of workflows to be displayed does not fit on panel 404, a user may navigate between multiple selection panels using the previous and next buttons 406 and 408 respectively.

For each workflow displayed in the selection panel 404 a variety of information is displayed including a name/description of the workflow, the applications making up the workflow, whether the user has “liked” the workflow, the cost of executing the workflow, and user review information in respect of the workflow.

Turning to the specific workflows that have been depicted by way of non-limiting example:

The first (topmost) workflow shown has a title/description 410 of “compress and send your file”. The applications used by the workflow are zip (i.e. a compression application) 412 and email 414. The user has not liked the workflow 416. The cost of executing the workflow 418 is 250 credits. The workflow has been reviewed by eight users and has an average rating of three stars 420.

The second workflow shown has a title/description 422 of “compress and send your file for free”. The applications used by the workflow are zip (i.e. a compression application) 424 and email 426 (which may or may not be identical to the zip and email applications 412 and 414 of workflow 410). The user has liked the workflow 428. Execution of the workflow is free 430. The workflow has been reviewed by 126 users and has an average rating of five stars 432.

The third workflow shown has a title/description 434 of “convert image and email (compressed)”. The applications used by the workflow are PNG2JPG 436, zip file 438, and email 440. The user has not liked the workflow 442. The cost of executing the workflow 444 is 800 credits. The workflow has not been reviewed by any users and as such has an average rating of zero stars 446.

The fourth workflow shown has a title/description 448 of “send SMS”. The application used by the workflow is SMS 450. The user has liked the workflow 452. The cost of executing the workflow 454 is 20 credits. The workflow has been reviewed by 32 users and has an average rating of two stars 456.

The fifth workflow shown has a title/description 458 of “post image on social networks”. The applications used by the workflow are resize 460, Facebook 462, Twitter 464, and Google+ 466. The user has liked the workflow 468. The cost of executing the workflow 470 is 1250 credits. The workflow has been reviewed by 58 users and has an average rating of one star 472.

The sixth (bottommost) workflow shown has a title/description 474 of “rotate and send SMS”. The applications used by the workflow are rotate 476 and SMS 478. The user has not liked the workflow 480. The cost of executing the workflow 482 is 25 credits. The workflow has been reviewed by 12 users and has an average rating of four stars 484.

A user may select any of the displayed workflows by clicking on the relevant workflow name or information. Selection of a workflow launches/navigates the user to a workflow execution interface, such as interface 600 as discussed below.

As with the workflow creation interface 200, the workflow selection interface 400 displays an account control 488 to provide access various user account tools and functions, and (where applicable) a field 486 showing the user their credit balance.

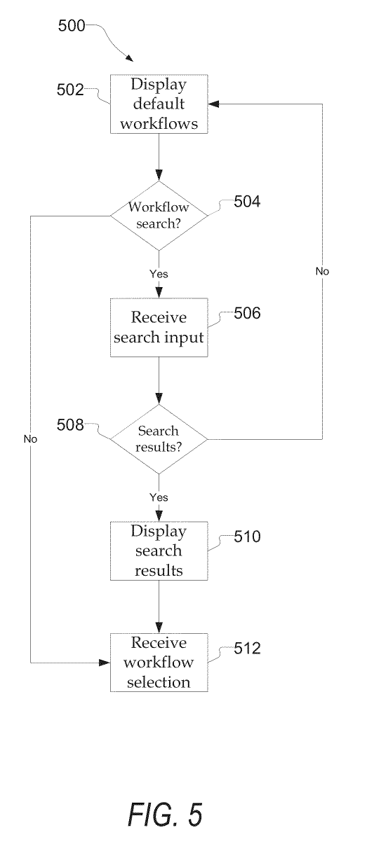

FIG. 5 is a flow chart illustrating a method 500 for selecting a workflow in accordance with an example embodiment of the invention. The method 500 may be enabled by any appropriate module, logic, or component described herein, and may be implemented using a workflow selection interface such as interface 400 described above.

At block 502 the system 102 displays a default list of workflows. This may, for example, be a list of workflows recently executed by the user, a list of the most popular workflows, a list of the cheapest workflows, or a random list of workflows.

At block 504 a user may elect to search for specific workflows. As describe above, such searching may be achieved in a number of ways. If a user enters a search, the search data is received at the system 102 at block 506. The search is processed by the system and if any search results satisfying the search criteria are identified (block 508), these are displayed at block 510. If no search results are identified the system alerts the user of this and, in this particular embodiment, displays again a default list of workflows.

If a user identifies a workflow they wish to execute (e.g. from the default list of workflows displayed at 502 or the search results displayed at 510), the workflow selection is received at the system 102 at block 512, and the user transferred to a workflow execution interface as discussed below.

Although presented as a flowchart, it will be appreciated that the steps/blocks involved in selecting a workflow need not be performed in the order shown.

### Workflow Execution

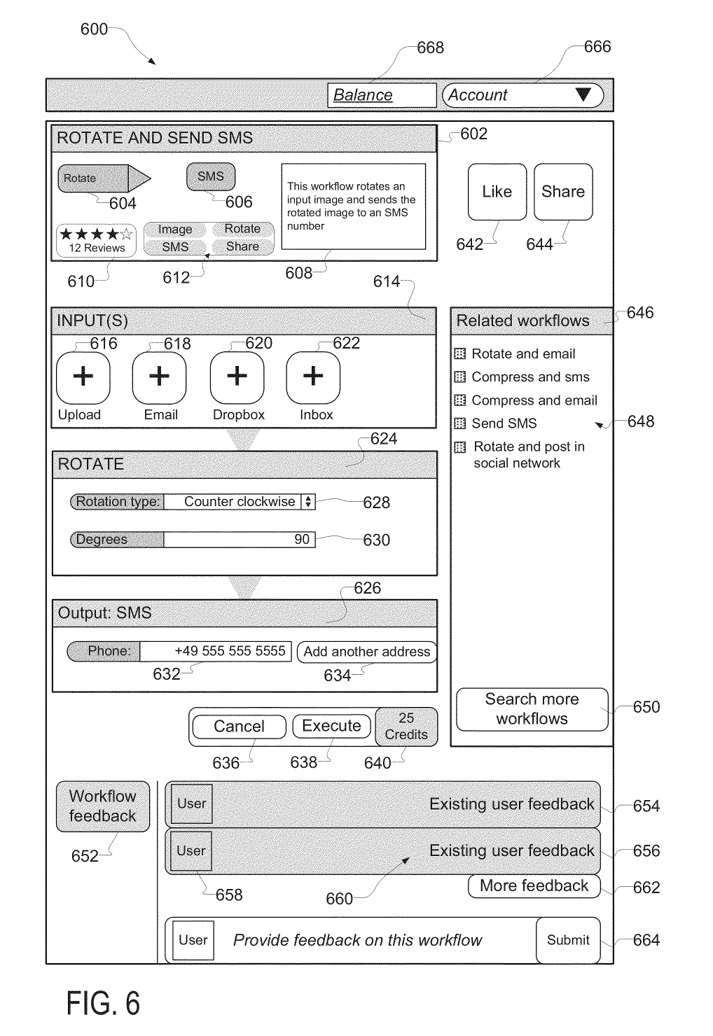

Once a workflow has been selected by a user, for example by use of a selection interface such as interface 400, an execution interface is provided for users to execute their selected workflow. FIG. 6 provides a depiction of a workflow execution interface 600 in accordance with an embodiment of the invention. For the purposes of illustration the workflow depicted in interface 600 is a rotate and SMS workflow which takes one or more content items, rotates it/them, and outputs the rotated content item(s) by one or more SMS messages.

Workflow execution interface 600 includes an information panel 602 which provides information regarding the selected workflow. Information panel 602 depicts the applications involved in the workflow (in this instance a rotate application 604 and an SMS application 606), a description of the workflow 608, an average rating of the workflow together with how many users have rated the workflow 610, and keywords that are associated with the workflow 612.

An input panel 614 is also provided, allowing users to select one or more input content items for the workflow. In this instance the input options are provided by way of input controls including an upload control 616, an email control 618, a dropbox control 620, and an inbox control 622. Activation of an input control may launch a pop-up or other interface by which the user can select the desired input content item (e.g. if a user selects to upload a content item a navigation interface will launch allowing the user to select a content item from a storage device attached to the users device). A user may select multiple input content items, either of the same or different input types. In this case the various parameters of the workflow (in this instance the rotation type and degrees, and the output phone number) will be applied to all input items. If executing the workflow in respect of multiple input items changes the cost of execution, this will also be updated for display in the execution cost field 640.

The workflow execution interface also includes one or more application panels in which the parameters of the application or applications involved in the workflow can be defined. In this case the workflow includes a rotate application and an SMS application, with application panels 624 and 626 respectively. Rotation application panel 624 allows the user to set the rotation type at parameter entry field 628 (to either clockwise or counter clockwise) and the degree of rotation at parameter entry field 630. SMS application panel 626 allows the user to select the phone number to which the SMS should be sent at parameter entry field 632, and provides the user with the option of adding an additional output SMS phone number via control 634 (should adding additional output addresses alter the cost of the workflow this is, again, updated in the execution cost field 640).

If the workflow being executed was created with saved parameters (e.g. via selection of a save checkbox associated with a parameter as described above), the saved parameters will be prepopulated for the user. In one embodiment any saved/prepopulated parameters may still be edited by the user (i.e. the saved parameters merely providing default values). In an alternative embodiment, saved/prepopulated parameters may be locked, preventing users from selecting alternative application parameters.

At any time a user can activate cancel control 636 to cancel execution of the workflow, and once at least one input has been selected and the relevant application parameters have been entered the user can execute the workflow by activation of the execute control 638. Should a user attempt to execute a workflow with missing parameters, the system 102 may alert the user to this and prompt the user to enter the required parameters.

The cost of executing the workflow with the currently selected input(s) and any application parameter is shown to the user at the execution cost field 640. In addition, a like control 642 allows a user to like and/or rate the workflow, and a share control 644 allows a user to share the workflow with one or more contacts.

A related workflow panel 646 shows a user related workflows 648 that may be of interest to the user, along with a search control 650 allowing the user to cancel the current workflow and search for an alternative workflow (e.g. by returning the user to/launching a workflow selection interface such as interface 400).

A workflow feedback area 652 is also displayed, showing feedback/comments from other users who have viewed and/or executed the current workflow. In this instance two feedback items 654 and 656 are displayed, each having user information 658 (e.g. a name of the user who contributed the feedback) and the feedback itself 660. If additional feedback items are available these can be accessed by the user by activation of the more feedback control 662. Should the user executing the workflow wish, they too can add feedback regarding the workflow by entering and submitting any feedback/comments in the feedback submission panel 664.

As with the workflow creation interface 200, and the workflow selection interface 400, the workflow execution interface 600 displays an account control 666 to provide access various user account tools and functions, and (where applicable) a field 688 showing the user their credit balance.

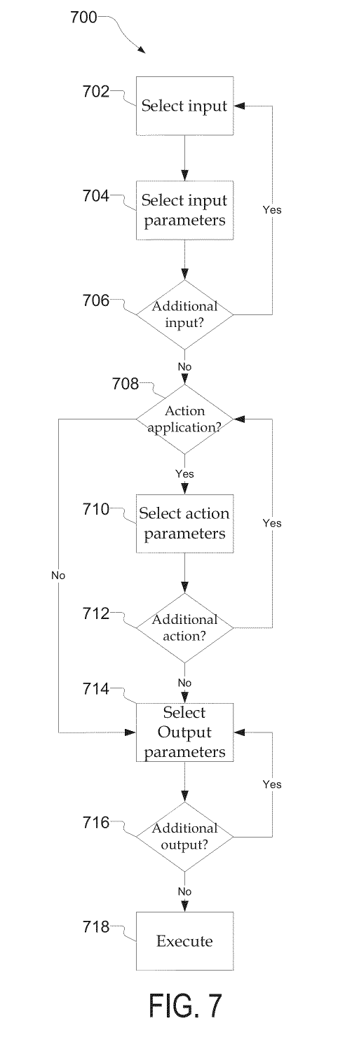

FIG. 7 is a flow chart illustrating a method 700 by which a user configures and elects to execute a workflow in accordance with an example embodiment of the invention. The method 700 may be enabled by any appropriate module, logic, or component described herein, and may be implemented using a workflow execution interface such as interface 600 described above.

In the embodiment depicted in FIG. 7 the workflow has not been created with a pre-defined input. Accordingly, at block 702 the user selects where/how the input content item to the workflow is to be accessed. At block 704 any relevant parameters for the selected input are entered. The precise parameters will depend on the input selected. For example, if the user wishes to upload a content item from a locally accessible storage device, the parameters will be a path to the content item. Alternatively, if the user wishes to access a content item from a networked location, the relevant parameters may include the network address and any relevant user credentials (e.g. user name and password). At 706 the user can elect to add an additional input to the workflow.

If the workflow includes any action applications (at block 708), any parameters required for those action applications are input at block 710. If the workflow includes multiple action applications (block 712), parameters required for all additional action applications are also entered. If application parameters were saved on the creation of the workflow, these will be pre-populated in the relevant parameter input fields for the user to see. In one embodiment the user may be able to alter saved parameters, though in an alternative embodiment parameters saved by the creator of the workflow may be locked and not editable by the user.

At block 714 the user inputs any parameters relevant to the output application (or applications) of the workflow. If the workflow includes multiple output applications (block 716), parameters for all additional output applications are also entered.

Once the user has entered all relevant workflow parameters they may select to execute the workflow. In this case the various information input by the user is sent to/received at the server at block 718, and the workflow is executed using those parameters as discussed below.

Once again, although presented as a flowchart the steps/blocks involved in a user executing a workflow need not be performed in the order shown.

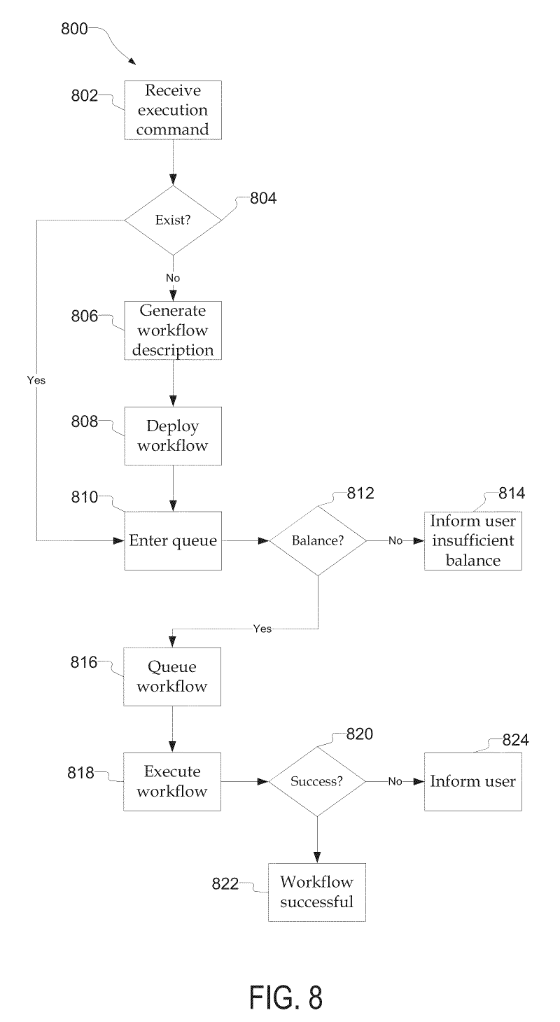

Once a command to execute a given workflow is received, workflow system 102 accesses the input content item(s), and performs the required processing and communications to execute the workflow. FIG. 8 is a flow chart illustrating a method 800 by which the workflow system 102 executes a workflow in accordance with an example embodiment of the invention. The method 800 may be enabled by any appropriate module, logic, or component described herein.

At block 802 an execution command with respect to a workflow is received.

At block 804 the system 102 checks to see whether a workflow description file for the workflow being executed is stored in memory.

If the relevant workflow description file does not exist, at block 806 the system 102 generates a workflow description file from the combination of applications in the workflow, and the defined parameter mappings for those applications. In one embodiment the workflow description file is a BPEL file, which describes the workflow based on the component web-services (applications) in a standard XML format. The workflow description file generated in block 806 is then deployed for execution at block 808.

At block 810, an execution command entry file for the workflow is entered into a workflow queue. In one embodiment the management of the workflow queue and execution is handled by the porthandler as discussed above. The executing command entry file for a workflow includes any parameters for the applications of the workflow, along with workflow metadata such as a user reference identifying the user executing the workflow and a timestamp recording the time at which the user submitted the command to execute the workflow.

At block 812 the system 102 checks the cost (e.g. a number of credits) required to execute the workflow against the balance of the user requesting execution. If the user balance is insufficient, the executing command entry file for the workflow is removed from the workflow queue and the user is advised of this at block 814. The system may then, for example, direct the user to an account management page allowing the user to add to their balance.

As will be appreciated, the job list may contain multiple workflow entry files generated by multiple users executing workflows. At block 816 the system determines the next workflow to be executed and commences execution of that workflow based on the job data (i.e. the information in the executing command entry file for the workflow). In one embodiment entries in the job list are executed sequentially on a first in first out basis, though alternative queuing options are, of course, possible.

At block 818 the system 102 sequentially calls/initiates the applications involved in the workflow. Parameter mapping and passing for each of the applications being executed is handled by the workflow application server 120, which uses the service API to communicate data/parameters with the relevant external servers on which the applications are executed. Management/calling of the various applications in a workflow is based on the workflow description file (e.g. BPEL file) generated for the workflow.

If all applications in the workflow are executed successfully (checked at block 820), a successful execution entry is generated and saved in a workflow history of the executing user, and the cost of the workflow execution is deducted from the user's balance (block 822). The user may also be informed of the successful execution, for example by displaying a dialogue on the user's machine, or otherwise communicating execution to the user (e.g. by email or sms).

If all applications in the workflow do not execute correctly, the user is informed on this at block 824. In this case the user may be prompted to try and re-execute the workflow, and/or to change parameters of the applications of the workflow.

### Developer Contribution

In addition to allowing users to create, select, and execute workflows, system 102 also allows developers to create specific applications for users to include in workflows. As noted above, the workflow applications used/accessed by system 102 in the execution of workflows are SOAP web services, allowing developers a large degree of freedom with respect to application development.

To facilitate correct operation, the system 102 may define certain requirements for applications that are to be submitted/executed. For example, system 102 may require applications to return certain defined output values such as a return value (indicating whether the application has successfully executed) and a return message (providing a message in respect of the execution of the application—e.g. “execution successful”, “execution failed”, “failed to send email: address incorrect”, or other message). In this case any applications written by developers will need to be written such that any mandatory requirements are satisfied.

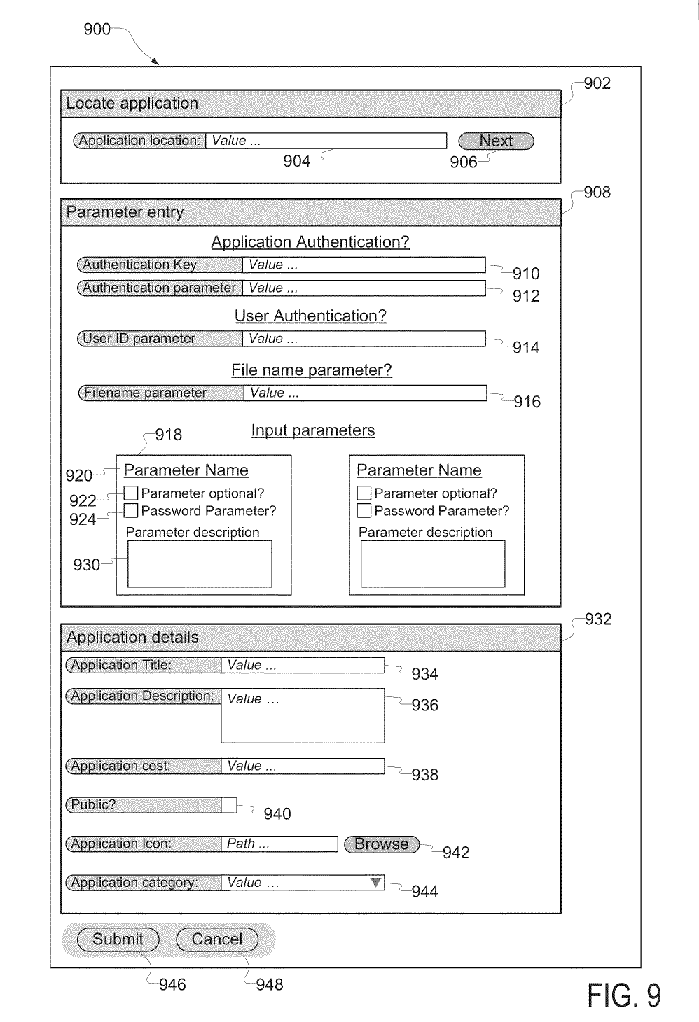

FIG. 9 provides a depiction of a developer contribution interface 900 in accordance with an embodiment of the invention. Interface 900 allows a developer who has developed an application to submit the application to the workflow system 102. Once submitted, users of the workflow system can use the application in workflows they create.

Developer contribution interface 900 includes a location specification panel 902 which includes a location field 904 allowing a developer to input a path to the application they wish to contribute. In the present embodiment the path provided by a developer will be a WSDL-URL to the location at which the application (SOAP web-service) is hosted—e.g. an external web server such as server 130.

Once the developer has entered a path to the application, the path can be submitted by the “next” button 906. If the path correctly identifies an application, the parameter entry panel 908 is displayed. If the path entered by the developer is not correct, an error message will be generated alerting the developer to this.

In some instances a developer may wish to limit access to their application. One way of doing this may be to define a certain system authentication parameter to which a specific value must be passed in order to execute the application. To cater for this, the parameter entry panel 908 includes entry fields 910 and 912 by which the developer can define a system authentication key parameter and a system authentication key value which is to be passed to that parameter to authenticate the system/enable use of the parameter.

Similarly, a developer may write an application that utilizes user or user group information. Such information may be used to restrict access to the application to certain users/user groups, or to allow the application to save/load data specific to the user calling (executing) the application as part of their workflow. To enable this functionality a user authentication parameter field 914 is also provided, allowing the developer to specify a parameter to which a user identification is passed when the application is called. (The actual value associated with this parameter is determined by the system 102 on execution with reference to the user implementing the workflow.)

Where an application needs to know the name of a file (content item), the developer can specify the parameter that the file name is to be passed to in the file name parameter field 916.

For each input parameter available for use with the application being contributed, a parameter entry box 918 is provided (in this instance only two parameter boxes are shown, though there may be more or fewer depending on the specific application in question. Each parameter entry box includes a parameter name field 920 (naming the parameter in question), an optional checkbox 922 (allowing the developer to specify whether the parameter is optional or mandatory), a password checkbox 924 (allowing the developer to specify whether the parameter is a password or not), and a description checkbox 930 (allowing the developer to enter a brief description of the parameter). By way of example, an e-mail application may include parameter entry boxes for the email body, a to email address, a cc email address, a bcc email address, a fail email address, a from email address, and attachment data.

Once all parameters have been defined, details of the application are entered in a details panel 932. In this specific embodiment the details a developer can define for a given application include an application title (field 934), an application description (field 936), a charge (e.g. a number of credits) that the user wishes to charge per execution of the application (field 938), an indication of whether the application is to be publicly available (checkbox 940), a location of an icon that is to represent the application (browse field 942), and a category for the application (drop down box 944). The application category may, for example, be an action category (indicating the application processes the input to return a processed—e.g. converted or modified—file) or an output category (indicating the application takes the input and outputs it in some way—e.g. email, print, sms, fax, post to a social network, stores it in an online account etc).

Once all information regarding the application has been entered, the developer can elect to save the information and make the application available by activating the submit control 946, or cancel the application contribution by activating cancel control 948.

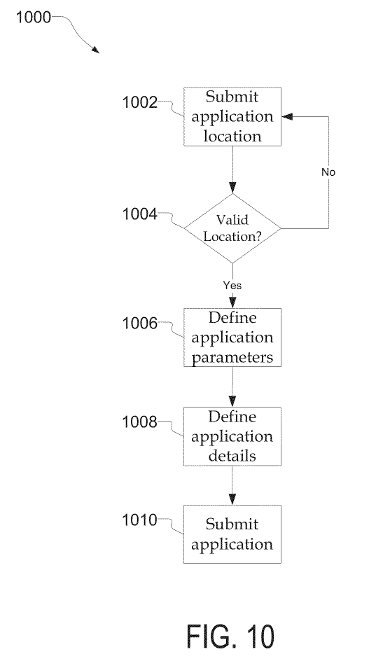

FIG. 10 is a flow chart illustrating a method 1000 by which a developer application can be contributed to the workflow system 102 and made available for use in workflows. The method 1000 may be enabled by any appropriate module, logic, or component described herein, and may be implemented using a developer contribution interface such as interface 1000 described above.

At block 1002 a developer enters and submits a location of the application they have prepared and wish to contribute to the workflow system. The location is checked by the workflow system at 1004 and, if valid, interfaces are provided to the user allowing the various parameters of the application to be defined.

At block 1006 the user defines the various parameters necessary for the specific application in question.

At block 1008 the user defines details of the workflow (e.g. title, description, cost, permissions, icon, category).

At block 1010 the user submits the application to the system 102.

Once the application has been submitted and processed by the system 102, it is made available to users to include in workflows (in accordance with any permissions defined by the developer).

### Revenue

In one embodiment of the invention revenue is generated by the workflow system 102 on an application execution basis.

As described above, each application has an execution cost—i.e. a cost that is charged to a user when the application is executed in a workflow run by a user. Some applications may have a zero cost. In the example described above, developers contributing applications to the system are afforded the opportunity of setting the per-execution charge on the applications they submit. In another embodiment, a user is charged a weekly or monthly subscription fee which allows a user to execute an unlimited number of applications during the subscription period. In other embodiments, the execution cost may be set by a system administrator.

The system administrator may also define a revenue sharing model. For example, every time an application is executed the system 102 may be configured to ascribe a certain percentage of the execution cost (e.g. 70%) to the developer who submitted the application, and keep the remaining percentage (e.g. 30%) for the system administrator/operator itself.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SAAS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine Readable Medium

FIG. 11 is a block diagram of machine in the example form of a computer system 1100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer implemented method, the method comprising:
receiving an input identifier identifying a digital content to be processed;
receiving a workflow identifier identifying a workflow, the workflow comprising a plurality of ordered applications; and
processing, using at least one processor, the digital content in accordance with the workflow to generate a final output.

2. The method of claim 1 wherein the processing of the digital content comprises:
passing an input to each application of the plurality of ordered applications for processing; and
receiving a processed content item from each application of the plurality of ordered applications.

3. The method of claim 2, wherein the input for a first application of the plurality of ordered applications is the digital content identified by the input identifier and the output of a final application of the plurality of applications is the final output.

4. The method of claim 2, wherein the plurality of ordered applications are each selected by a user.

5. The method of claim 4, wherein each application of the plurality of applications is one of either an input application, an action application, or an output application.

6. The method of claim 4, wherein each of the applications of the plurality of applications have an associated execution cost, the associated execution cost being charged to the user each time the application is executed.

7. The method of claim 1, wherein the workflow is selected by the user from a list of available workflows.

8. The method of claim 7, wherein the list of available workflows includes a user rating for each workflow.

8. The method of claim 1, wherein the digital content to be processed is a plurality of associated digital content items located in a directory.

9. The method of claim 7, further comprising:
detecting the addition of a new content item to the directory containing the plurality of associated digital content items; and
processing the new content item in accordance with the workflow.

10. The method of claim 1, wherein the plurality of ordered applications is Simple Object Access Protocol (SOAP) web-services.

11. The method of claim 1, wherein the input identifier includes an additional parameter, the additional parameter being necessary for the execution of at least one of the applications of the plurality of ordered applications.

13. A computer system, comprising:
an application program interface server, the application program server configured to receive a input identifier and a workflow identifier, the input identifier indentifying digital content to be processed, the workflow identifier identifying a workflow, the workflow comprising a plurality of ordered applications; and
a workflow application server coupled to the application program interface server, the workflow application server being configured to execute the workflow on the digital content to generate a final output.

14. The computer system of claim 13, wherein the executing of the workflow on the digital content comprises:
passing an input to each application of the plurality of ordered applications for processing; and
receiving a processed content item from each application of the plurality of ordered applications.

15. The computer system of claim 13, further comprising;
a polling module coupled to the application program interface server, the polling module being configured to:
detect the addition of a new content item to a content directory, the content directory comprising a plurality of digital content items; and
transmit a notification, the notification identifying the new content item and its location; and
a download module coupled to the application program interface, the downloader module being configured to:
receive the notification from the polling module;
download the new content item; and
transmit the new content item to the application server to be process in accordance with the workflow.

16. The computer system of claim 16, wherein the workflow has an associated execution cost charged to the user each time the workflow is executed, the associate execution cost being the aggregate of the per-execution cost of each of the applications in the plurality of applications.

17. The computer system of claim 16, further comprising an administrative application server, the administrative application server being configured to allow the user to accumulate a value in a user account, the value to be applied toward the execution cost associated with the execution of the workflow.

18. The computer system of claim 13, wherein the application program interface server is further configured to communicate with an external server, the communication providing the ability to execute an application located on the external server.

19. The computer system of claim 18, wherein the plurality of applications includes an application hosted on an external server.

20. A machine-readable medium comprising instructions, which, when implemented by one or more machines, cause the one or more machines to perform the following operations:
receive an input identifier identifying the digital content to be processed;
receive a workflow identifier identifying the workflow, the workflow comprising a plurality of ordered applications; and
process the digital content item in accordance with the workflow to generate a final output.
